(19) United States
(12) Patent Application Publication
(10) Pub. No.: US 2026/0135752 A1
(43) Pub. Date: May 14, 2026

(54) MACHINE LEARNING BASED FRAMEWORK FOR DETECTION AND TROUBLESHOOTING OF NETWORK RELATED ISSUES IN LARGE STORAGE FABRICS

(71) Applicant: Dell Products L.P., Round Rock, TX (US)

(72) Inventors: Shaul Dar, Petach Tikva (IL); Boris Glimcher, Brooklyn, NY (US); Erik Smith, Douglas, MA (US); Ramakanth Kanagovi, Hyderabad (IN)

(21) Appl. No.: 18/945,735

(22) Filed: Nov. 13, 2024

(51) Int. Cl. H04L 41/0631; H04L 41/16

(52) U.S. Cl. CPC H04L 41/0631; H04L 41/16

(57) ABSTRACT

Techniques for providing a machine learning (ML)-based framework for detecting and troubleshooting network-related issues in large storage fabrics. The techniques include detecting, based on an output of an ML model, a network-related issue in a distributed storage infrastructure. The ML model operates on telemetry data obtained from network elements, and computing/storage nodes on a storage network. A multilayer representation of the storage network includes a physical layer, a logical layer, and a service layer. The techniques include obtaining a correlation between the network-related issue and an activity, service, or status of the network elements/nodes in two or more layers of the multilayer representation. The correlation identifies a context of the network-related issue with respect to the network elements/nodes in the two or more layers. The techniques include providing an in-context alert pertaining to the network-related issue to at least one administrator of the network elements/nodes within the storage network.

### BACKGROUND

Distributed storage systems in networked environments typically include scalable software-defined storage and/or clustered virtual or physical infrastructures. The distributed storage systems include a multitude of computing nodes and storage nodes, which have networking components, server components, and/or associated storage devices. The distributed storage systems receive data access requests over storage networks or fabrics from host computers (“hosts”). The data access requests include write requests to store data on storage objects maintained on the storage devices, and read requests to access data stored on the storage objects. The hosts and the storage networks/fabrics are managed and/or controlled by host administrators and network administrators, respectively. The storage objects (e.g., volumes, logical units, filesystems) are managed and/or controlled by storage administrators on behalf of the hosts.

### SUMMARY

In recent years, distributed storage systems have evolved with increasing complexity and operational requirements. For example, distributed storage systems may include dozens, hundreds, or even thousands of computing and/or storage nodes (or servers) communicably coupled to intricate storage network or fabric topologies, using disparate network protocols (e.g., TCP/IP (Transmission Control Protocol/Internet Protocol), Ethernet, InfiniBand (IB), NVMe (Non-Volatile Memory express), RDMA (Remote Direct Memory Access)) and network components (e.g., NICs (Network Interface Cards), routers, switches, gateways, servers, aggregators, links, cables, wireless connectivity). As such, the ability to detect and troubleshoot network issues pertaining to distributed storage systems (e.g., node failure, network congestion, suboptimal network performance, network or node misconfiguration) has become essential to ensure their reliable and seamless operation. The development of network issue detection and troubleshooting capabilities has faced roadblocks, however, due, at least in part, to difficulties in obtaining unified and comprehensive end-to-end telemetry data, metrics, and/or statistics from distributed network and storage resources, which may be provided by different vendors and/or manufacturers. Moreover, host, network, and/or storage administrators may be incapable of successfully viewing, accessing, using, and/or interpreting such telemetry data, metrics, and/or statistics information. For example, a computing/storage node failure or other network-related issue or problem in a distributed storage infrastructure may trigger an action or process that causes increased network traffic and/or congestion, resulting in some clients experiencing elongated response times and/or IO timeouts affecting IO performance. However, because host, network, and storage administrators manage and/or control separate areas of the distributed storage infrastructure, they often fail to have clear insights into the precise cause of such a problem, the overall impact of the problem, what administrator has primary responsibility for the problem, how the problem might be addressed or remediated, and so on, possibly leading to IO performance degradation and/or unwanted downtime and client dissatisfaction.

Techniques are disclosed herein for providing a machine learning (ML)-based framework (“framework”) for detecting and troubleshooting network-related issues in large storage networks or fabrics. The framework can be deployed within a distributed storage infrastructure, or maintained locally at a dark site or other such site not connected to a public/private cloud or network. The framework can encompass a plurality of executable software/firmware systems, components, and microservices, some or all of which can be implemented in a cloud-based, centralized analytics server computer (“analytics server”). The framework can include a telemetry preprocessing component, a feature engineering component, a feature database (DB), an ML component, an ML model repository, and an inferencing microservice. The framework can further encompass specialized framework client components (“framework clients”) and specialized framework server components (“framework servers”), which can be implemented as part of, embedded with, or otherwise associated with network elements, computing nodes, storage nodes, and/or storage devices communicably coupled to a network, which can be a distributed storage network. The framework clients can collect telemetry data pertaining to their associated network elements and/or computing/storage nodes, and forward or stream the telemetry data over the network to the framework servers. The analytics server can obtain the telemetry data from the framework servers, and use the framework to perform model inference on the telemetry data to infer one or more issues related to the network. The analytics server can maintain a multilayer representation of the network that includes a physical layer, a logical layer, and a service layer, and obtain a correlation between the network-related issue and an activity, service, or status of the network elements and/or computing/storage nodes with respect to the physical layer, the logical layer, and/or the service layer, thereby identifying a context of the network-related issue based on the correlation. Having identified the context of the network-related issue, the analytics server can generate and send an in-context alert to one or more of the framework servers, which can forward the in-context alert to one or more of the framework clients to provide appropriate host, network, and/or storage administrators with relevant, informative, useful, and/or actionable notifications of the network-related issue.

In certain embodiments, a method includes detecting a network-related issue in a network of a plurality of network nodes based on an output of one or more machine learning (ML) models. The ML models operate on telemetry data obtained from the respective network nodes. A multilayer network representation of the network includes a service layer, a logical layer, and a physical layer. The method includes obtaining a correlation between the network-related issue and a service, an activity, or a status of one or more network nodes from among the plurality of network nodes in relation to the service layer, the logical layer, and the physical layer of the multilayer network representation. The correlation identifies a context of the network-related issue in relation to the service layer, the logical layer, and the physical layer. The method includes sending, to the network nodes, an in-context alert based on the context of the network-related issue.

In certain arrangements, the method includes providing a computer-executable framework for detecting the network-related issue and obtaining the correlation between the network-related issue and the service, the activity, or the status of the network nodes. The computer-executable framework includes at least an ML model repository, an inferencing engine, and a specialized server component.

In certain arrangements, the plurality of network nodes includes a plurality of computing nodes. The method includes providing a specialized client component associated with each respective computing node.

In certain arrangements, the method includes collecting, by the specialized client component, telemetry data pertaining to each respective computing node, and forwarding the telemetry data to the specialized server component.

In certain arrangements, the method includes obtaining information pertaining to the service layer, the logical layer, and the physical layer of the multilayer network representation. The obtained information indicates the network-related issue associated with a network node from among the plurality of network nodes. The network-related issue causes performance degradation on the network.

In certain arrangements, the method includes accessing at least one ML model from the ML model repository, accessing the telemetry data from the specialized server component, and performing inference, by the inferencing engine, on the telemetry data using the ML model.

In certain arrangements, the method includes correlating the network-related issue with the service performed by the network nodes in the service layer, the activity performed by the network nodes in the logical layer, and the status of the network nodes in the physical layer.

In certain arrangements, the method includes suggesting a troubleshooting action to be performed regarding the network-related issue.

In certain embodiments, a system includes a memory, and processing circuitry configured to execute program instructions out of the memory to detect a network-related issue in a network of a plurality of network nodes based on an output of one or more machine learning (ML) models. The ML models operate on telemetry data obtained from the respective network nodes. A multilayer network representation of the network includes a service layer, a logical layer, and a physical layer. The processing circuitry is configured to execute the program instructions out of the memory to obtain a correlation between the network-related issue and a service, an activity, or a status of one or more network nodes from among the plurality of network nodes in relation to the service layer, the logical layer, and the physical layer of the multilayer network representation. The correlation identifies a context of the network-related issue in relation to the service layer, the logical layer, and the physical layer. The processing circuitry is configured to execute the program instructions out of the memory to send, to the network nodes, an in-context alert based on the context of the network-related issue.

In certain arrangements, the processing circuitry is configured to execute the program instructions out of the memory to provide a computer-executable framework for detecting the network-related issue and obtaining the correlation between the network-related issue and the service, the activity, or the status of the network nodes. The computer-executable framework includes at least an ML model repository, an inferencing engine, and a specialized server component.

In certain arrangements, the plurality of network nodes includes a plurality of computing nodes. The processing circuitry is configured to execute the program instructions out of the memory to provide a specialized client component associated with each respective computing node.

In certain arrangements, the processing circuitry is configured to execute the program instructions out of the memory to collect, by the specialized client component, telemetry data pertaining to each respective computing node, and to forward the telemetry data to the specialized server component.

In certain arrangements, the telemetry data includes at least some of:
a number of discarded packets (DiscardedPkts);
a number of FCOE/IP login failures (FCOElinkFailures);
a number of good (FCS valid) packets received (FCOEPktRxCount);
a number of good (FCS valid) packets transmitted (FCOEPktTxCount);
a total number of RDMA packets received (RDMARxTotalPackets);
a total number of RDMA bytes transmitted (RDMATxTotalBytes);
a total number of RDMA packets transmitted (RDMATxTotalPackets);
a number of bytes received (RxBytes);
a number of packets received with FCS errors (RxErrorPktFCSErrors);
a number of frames that are too long (RxJabberPkt); and
a number of bytes transmitted (TxBytes).

In certain arrangements, the telemetry data includes at least some of:
a total number of FC CRC errors (FCCRCErrorCount);
a number of bad (FCS invalid) packets dropped (FCOERxPktDroppedCount);
a number of LAN FCS errors received (LanFCSRxErrors);
a number of LAN unicast packets received (LanUnicastPktRxCount);
a number of LAN unicast packets received (LanUnicastPktTxCount);
a status of a link (LinkStatus);
an operating system driver state (OSDriverState);
a status of a partition link (PartitionLinkStatus);
a partition operating system driver state (PartitionOSDriverState);
a total number of RDMA bytes received (RDMARxTotalBytes);
a total number of RDMA protection errors (RDMATotalProtectionErrors);
a total number of RDMA protocol errors (RDMATotalProtocolErrors);
a total number of RDMA transmit packets read (RDMATxTotalReadReqPkts); and
a total number of RDMA transmit packets sent (RDMATxTotalSendPkts).

In certain arrangements, the telemetry data includes at least some of:
a total number of RDMA transmit packets written (RDMATxTotalWritePkts);
a number of broadcast packets received (RxBroadcast);
a number of packets received with alignment errors (RxErrorPktAlignmentErrors);
a number of false carrier/receive detected (RxFalseCarrierDetection);
a number of multicast packets received (RxMutlicast);
a number of transmit OFF frames (receive pause) transmitted (RxPauseXOFFFrames);
a number of transmit ON frames (receive pause) transmitted (RxPauseXONFrames);
a number of runt packets received (RxRuntPkt);
a number of unicast packets received (RxUnicast);
a number of broadcast packets received (TxBroadcast);
a number of multicast packets transmitted (TxMutlicast);
a number of transmit OFF frames (transmit pause) received (TxPauseXOFFFrames);
a number of transmit ON frames (transmit pause) received (TxPauseXONFrames); and
a number of unicast packets transmitted (TxUnicast).

In certain arrangements, the processing circuitry is configured to execute the program instructions out of the memory to obtain information pertaining to the service layer, the logical layer, and the physical layer of the multilayer network representation. The obtained information indicates the network-related issue associated with a network node from among the plurality of network nodes. The network-related issue causes performance degradation on the network.

In certain arrangements, the processing circuitry is configured to execute the program instructions out of the memory to access at least one ML model from the ML model repository, to access the telemetry data from the specialized server component, and to perform inference, by the inferencing engine, on the telemetry data using the ML model.

In certain arrangements, the processing circuitry is configured to execute the program instructions out of the memory to correlate the network-related issue with the service performed by the network nodes in the service layer, the activity performed by the network nodes in the logical layer, and the status of the network nodes in the physical layer.

In certain arrangements, the processing circuitry is configured to execute the program instructions out of the memory to suggest a troubleshooting action to be performed regarding the network-related issue.

In certain embodiments, a computer program product includes a set of non-transitory, computer-readable media having program instructions that, when executed by processing circuitry, cause the processing circuitry to perform a method including detecting a network-related issue in a network of a plurality of network nodes based on an output of one or more machine learning (ML) models. The ML models operate on telemetry data obtained from the respective network nodes. A multilayer network representation of the network includes a service layer, a logical layer, and a physical layer. The method includes obtaining a correlation between the network-related issue and a service, an activity, or a status of one or more network nodes from among the plurality of network nodes in relation to the service layer, the logical layer, and the physical layer of the multilayer network representation. The correlation identifies a context of the network-related issue in relation to the service layer, the logical layer, and the physical layer. The method includes sending, to the network nodes, an in-context alert based on the context of the network-related issue.

Other features, functions, and aspects of the present disclosure will be evident from the Detailed Description that follows.

### BRIEF DESCRIPTION OF THE DRAWINGS

The foregoing and other objects, features, and advantages will be apparent from the following description of particular embodiments of the present disclosure, as illustrated in the accompanying drawings, in which like reference characters refer to the same parts throughout the different views.

FIG. 1 is a block diagram of an exemplary system environment, in which techniques can be practiced for providing a machine learning (ML)-based framework for detecting and troubleshooting network-related issues in large storage networks or fabrics;

FIG. 2 is a block diagram of an exemplary ML-based framework for detecting and troubleshooting network-related issues in large storage networks or fabrics in the system environment of FIG. 1;

FIG. 3 is a block diagram of an exemplary multilayer representation of a large storage network or fabric that can be used to identify a context of a network-related issue with respect to one or more network elements, computing nodes, and/or storage nodes on the large storage network or fabric; and

FIG. 4 is a flow diagram of an exemplary method of providing an ML-based framework for detecting and troubleshooting network-related issues in large storage networks or fabrics.

### DETAILED DESCRIPTION

Techniques are disclosed herein for providing a machine learning (ML)-based framework for detecting and troubleshooting network-related issues in large storage networks or fabrics. The framework can encompass a plurality of executable software/firmware systems, components, and microservices, some or all of which can be implemented in a cloud-based, centralized analytics server computer (“analytics server”). The framework can encompass framework client components (“framework clients”) and framework server components (“framework servers”), which can be implemented as part of, embedded with, or otherwise associated with network elements, computing nodes, storage nodes, and/or storage devices on a network. The framework clients can collect telemetry data, metrics, and/or statistics pertaining to their associated network elements and/or computing/storage nodes (or servers), and forward or stream the telemetry data over the network to the framework servers. The analytics server can obtain the telemetry data from the framework servers, and perform model inference on the telemetry data to infer one or more issues related to the network. The analytics server can obtain a correlation between the network-related issue and an activity, service, or status of the network elements and/or computing/storage nodes with respect to a physical layer, a logical layer, and/or a service layer of a multilayer representation of the network, thereby identifying a context of the network-related issue based on the correlation. Having identified the context of the network-related issue, the analytics server can generate and send an in-context alert to one or more of the framework servers, which can forward the in-context alert to one or more of the framework clients to provide appropriate host, network, and/or storage administrators with relevant, informative, useful, and/or actionable notifications of the network-related issue.

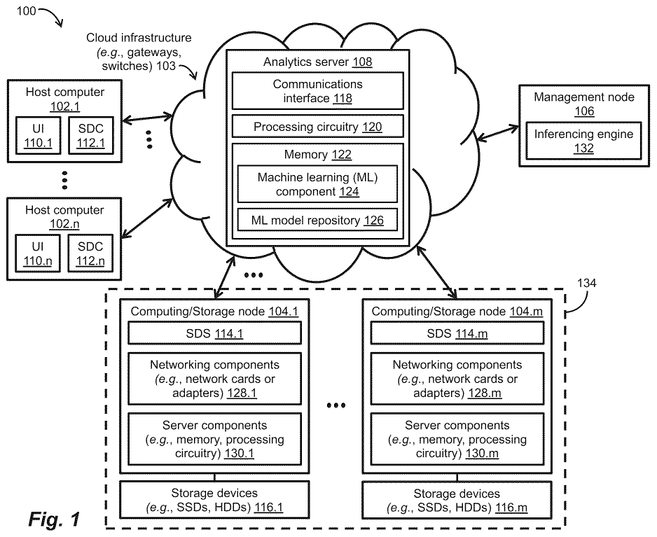

FIG. 1 depicts an illustrative embodiment of an exemplary system environment 100 for providing an ML-based framework for detecting and troubleshooting network-related issues in large storage networks or fabrics. As shown in FIG. 1, the system environment 100 can include a plurality of host computers (“hosts”) 102.1, . . . , 102.n and a distributed storage system 134, all of which can be communicably coupled to a central analytics server 108 over a cloud infrastructure (e.g., gateways, switches) 103. The distributed storage system 134 can include computing and/or storage (“computing/storage”) nodes (or servers) 104.1, . . . , 104.m, which can include network components (e.g., NICs (Network Interface Cards), network interface adapters) 128.1, . . . , 128.m, respectively, and server components (e.g., memory, processing circuitry) 130.1, . . . , 130.m, respectively. The computing/storage nodes 104.1, . . . , 104.m can be associated with storage devices (e.g., solid state drives (SSDs), hard disk drives (HDDs)) 116.1, . . . , 116.m, respectively. In one embodiment, the network components 128.1 can be configured into a networking domain, the server components 130.1 can be configured into a server domain, and the storage devices (e.g., SSDs, HDDs) 116.1 can be configured into a storage disk/drive domain. Likewise, the network components 128.m can be configured into a networking domain, the server components 130.m can be configured into a server domain, and the storage devices (e.g., SSDs, HDDs) 116.m can be configured into a storage disk/drive domain.

Each of the plurality of hosts 102.1, . . . , 102.n can provide, over the cloud infrastructure 103, data access requests (e.g., small computer system interface (SCSI) commands, network file system (NFS) commands) to one or more of the computing/storage nodes 104.1, . . . , 104.m. The data access requests (e.g., write requests, read requests) can direct the computing/storage nodes 104.1, . . . , 104.m to write and/or read datasets including data blocks, data pages, data files, or any other suitable data elements, to/from volumes (VOLs), virtual volumes (VVOLs) (e.g., VMware® VVOLs), logical units (LUs), filesystems, or any other suitable storage objects, maintained on one or more of the storage devices 116.1, . . . , 116.m, respectively. The plurality of hosts 102.1, . . . , 102.n can include, or be associated with, a plurality of user interfaces (UIs) 110.1, . . . , 110.n, respectively, each of which can be implemented on a touchscreen display or any other suitable user interface (UI). In one embodiment, a plurality of storage data clients (SDCs) 112.1, . . . , 112.n can be deployed on the plurality of hosts 102.1, . . . , 102.n, respectively, and a plurality of storage data servers (SDSs) 114.1, . . . , 114.m can be deployed on the plurality of computing/storage nodes 104.1, . . . , 104.m, respectively. The SDCs 112.1, . . . , 112.n can provide operating systems (or hypervisors) of the respective hosts 102.1, . . . , 102.n access to block storage objects (e.g., volumes) currently mapped to the hosts 102.1, . . . , 102.n. Because the SDCs 112.1, . . . , 112.n have knowledge of which SDSs 114.1, . . . , 114.m hold their block data, multipathing can be accomplished natively through the SDCs 112.1, . . . , 112.n.

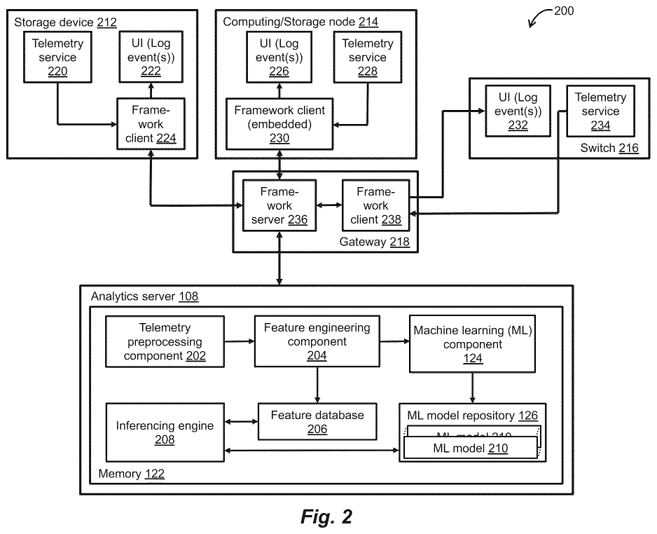

As shown in FIG. 1, the analytics server 108 can include a communications interface 118, processing circuitry 120, and a memory 122. The communications interface 118 can include an Ethernet interface, an InfiniBand interface, a Fibre Channel (FC) interface, or any other suitable interface. The communications interface 118 can further include SCSI target adapters, network interface adapters, or any other suitable cards or adapters for converting electronic, optical, or wireless signals received over the cloud infrastructure 103 to a form suitable for use by the processing circuitry 120. The processing circuitry 120 (e.g., central processing unit (CPU)) can include a set of processing cores (e.g., CPU cores) configured to execute framework software/firmware code, components, logic, engines, and/or modules as program instructions out of the memory 122. The memory 122 can include volatile memory, such as random access memory (RAM) or any other suitable volatile memory, and nonvolatile memory, such as nonvolatile RAM (NVRAM) or any other suitable nonvolatile memory. The memory 122 can accommodate an operating system (OS) (e.g., Linux, Unix, Windows), as well as a variety of specialized software/firmware constructs including an ML component 124 and an ML model repository 126, which are described herein with reference to an ML-based, network-related issue detection and troubleshooting framework 200 (“framework”) (see FIG. 2). The framework 200 can be deployed within a distributed storage infrastructure. In one embodiment, the framework 200 can be partially deployed in a management layer of a network. As such, the system environment 100 can include a management node 106, which can have an inferencing engine 132. The management node 106 can access, over the network, one or more trained ML models 210 (see FIG. 2) from the ML model repository 126 of the analytics server 108, as well as telemetry data, metrics, and/or statistics obtained by the analytics server 108 from throughout the distributed storage infrastructure. Using the inferencing engine 132, the management node 106 can perform model inference on the telemetry data to infer one or more issues related to the network coupling the hosts 102.1, . . . , 102.n and/or the management node 106 to the distributed storage system 134.

FIG. 2 depicts an exemplary embodiment of the framework 200, which can be deployed and maintained as part of the distributed storage infrastructure. As shown in FIG. 2, the framework 200 can encompass a plurality of executable software/firmware systems, components, and microservices implemented in the memory 122 of the analytics server 108, including a telemetry preprocessing component 202, a feature engineering component 204, a feature database (DB) 206, and an inferencing engine 208, and as well as the ML component 124 and the ML model repository 126, which can store the plurality of trained ML models 210. The framework 200 can further encompass a plurality of specialized framework client components (“framework clients”) and a plurality of specialized framework server components (“framework servers”), which can be implemented as part of, embedded with, or otherwise associated with network elements (e.g., gateways, switches), computing nodes, storage nodes, and/or storage devices communicably coupled to the network. For example, a framework client 224 may be implemented as part of a storage device 212, and a framework client 230 may be embedded with a computing or storage (“computing/storage”) node 214. Further, a framework client 238 and a framework server 236 may be implemented as part of a gateway 218. The framework client 238 may also be associated with a network switch (“switch”) 216. As such, the framework client 224 can collect, via a telemetry service (or engine) 220, telemetry data pertaining to the storage device 212, and the framework client 230 can collect, via a telemetry service (or engine) 228, telemetry data pertaining to the computing/storage node 214. Further, the framework client 238 can collect, via a telemetry service (or engine) 234, telemetry data pertaining to the switch 216. For example, such telemetry data, metrics, and/or statistics may be stamped with topological information (e.g., the identity of a network element or device that produced the telemetry data, metrics, and/or statistics, the identity of a link or path where a failure event occurred), as well as a timestamp. Having collected the telemetry data (or metrics, statistics), the framework client 224, the framework client 230, and the framework client 238 can forward or stream the telemetry data to the framework server 236. The analytics server 108 can obtain the collected telemetry data from the framework server 236, and use the framework software/firmware systems, components, and microservices implemented in the memory 122 to perform model inference on the telemetry data to infer one or more issues related to the network.

It is noted that network switches, such as the switch 216, can provide application programming interfaces (APIs) that enable telemetry data, metrics, and/or statistics (“telemetry information”) to be sent to or retrieved from the network switches. For example, such APIs may enable telemetry information to be streamed to and from the network switches. In some instances, however, access authorization (e.g., “read-only” access) can be required to obtain such telemetry information, not only from network switches, but also from computing or storage nodes (or servers), such as the computing/storage node 214, as well as storage devices, such as the storage device 212. In one embodiment, a software agent can be installed on a switch, server, or storage device to fetch telemetry information locally from the switch, server, or storage device, and stream it to a data aggregator component of the framework 200. For example, such telemetry information may be obtained in response to a request from the analytics server 108. Alternatively, such telemetry information may be “pushed” to the analytics server 108, without requiring any such request to “pull” the telemetry information. In another embodiment, to alleviate possible authentication, security, or administrative concerns, an accessible subset of telemetry information can be fetched from the switch, server, or storage device, while avoiding installation of a software agent. It is further noted that model inference can be performed on the telemetry information by the analytics server 108 (e.g., a cloud-based central server) using the inferencing engine 208, or by the management node (e.g., in the management layer) 106 using the inferencing engine 132.

In response to the telemetry data being obtained from the framework server 236, the telemetry preprocessing component 202 can clean the telemetry data, and transform the telemetry data from unstructured telemetry data to structured telemetry data. In one embodiment, the switch 216, the computing/storage node 214, and the storage device 212 can include hardware, software, and/or firmware components assigned to multiple different domains, such as a networking domain (e.g., network interface cards, adapters), a server domain (e.g., memory, processing circuitry), and a storage domain (e.g., SSDs, HDDs). Further, the telemetry preprocessing component 202 can access unstructured telemetry data streams from separate queues specific to the network, server, and storage domains, and, for each different domain, perform, on the telemetry data streams, cleaning and transformation techniques, normalization techniques (e.g., min-max scaling), missing value handling techniques (e.g., forward/backward filling, interpolation), temporal alignment techniques, and so on.

The feature engineering component 204 can receive the telemetry data as sets of telemetry variables specific to the network, server, and storage domains, and perform feature engineering on the sets of telemetry variables to derive features (or attributes) relevant to issues related to the network. For example, such feature engineering may include performing various tasks, such as feature selection, dimensionality reduction, scaling, and so on, as well as integrating domain-specific knowledge with statistical and/or time-series analyses. Further, to capture the temporal nature and interaction of the telemetry variables over time, the feature engineering component 204 may derive time-lagged variables (e.g., telemetry variables lagged over various time steps to capture temporal dependencies), rolling statistics (e.g., rolling means features, standard deviation features, and/or moving average features calculated over different time windows to identify trends and/or anomalies), derived metrics (e.g., ratios and/or differences between key metrics to identify potential network congestion points), and so on. Having derived the features relevant to network-related issues, the features, and optionally the structured telemetry data from which the features were derived, can be stored in the feature DB 206.

The ML component 124 can receive the features relevant to issues related to the network, train, validate, and test one or more ML algorithms using at least some of the features information, and generate one or more ML models (e.g., ML model(s) 210) based on the ML algorithm(s). For example, to satisfy certain network-related issue detection requirements, the ML component 124 may train regression algorithms, classification algorithms, and/or any other suitable supervised ML algorithms, to detect or quantify specific types of network-related issues (e.g., network or node misconfiguration, node failure, network congestion, suboptimal network performance). The ML component 124 may also train multi-class (or multi-label) classification algorithms, obtaining the labels from real world field data. Further, the ML component 124 may train anomaly detection algorithms or any other suitable unsupervised ML algorithms. In addition, to enhance performance of the ML model(s) 210, the ML component 124 can employ various configuration techniques, such as cross-validation, hyperparameter tuning, and/or ensemble learning with centralized configuration management (e.g., GitHub®). In one embodiment, the ML models 210 can be deployed as microservices in a containerized environment (e.g., Docker®, Kubernetes®), allowing each containerized microservice to be independently managed and scaled, as well as efficiently and dynamically integrated and orchestrated with other framework services, as desired and/or required.

The inferencing engine 208 can access datasets of recently obtained features from the feature DB 206, as well as access one or more ML models (e.g., ML model(s) 210) from the ML model repository 126, to detect and troubleshoot issues related to the network. In response to processing the datasets using the ML model(s) 210, the inferencing engine 208 can detect, by model inference, one or more network-related issues, such as network or node misconfiguration, node failure, network congestion, suboptimal network performance, and so on. In one embodiment, the analytics server 108 can maintain a multilayer representation of the network that includes a physical layer, a logical layer, and a service layer. Further, the inferencing engine 208 can obtain a correlation between a network-related issue and an activity, service, or status of a network switch (e.g., the switch 216), a computing or storage node (e.g., the computing/storage node 214), and/or a storage device (e.g., the storage device 212) with respect to the physical layer, the logical layer, and/or the service layer, thereby identifying a context of the network-related issue based on the correlation. For example, such an identified context may refer to a condition or situation that gives enhanced meaning to a network-related issue, event, behavior, or concern. Having identified the context of the network-related issue, the inferencing engine 208 can generate and send an in-context alert to the framework server 236, which can forward the in-context alert to one or more of the framework clients 224, 230, 238. The framework client 224 can pass in-context alerts to a user interface (UI) 222 of the storage device 212, the framework client 230 can pass in-context alerts to a UI 226 of the computing/storage node 214, and the framework client 238 can pass in-context alerts to a UI 232 of the switch 216. Further, the framework clients 224, 230, 238 can create log events (e.g., date/time, cluster/node number, component, logging level, text) based on the in-context alerts forwarded by the framework server 236, and display the log events on the respective UIs 222, 226, 232. In this way, appropriate host, network, and/or storage administrators can be provided with relevant, informative, useful, and/or actionable notifications of issues related to the network.

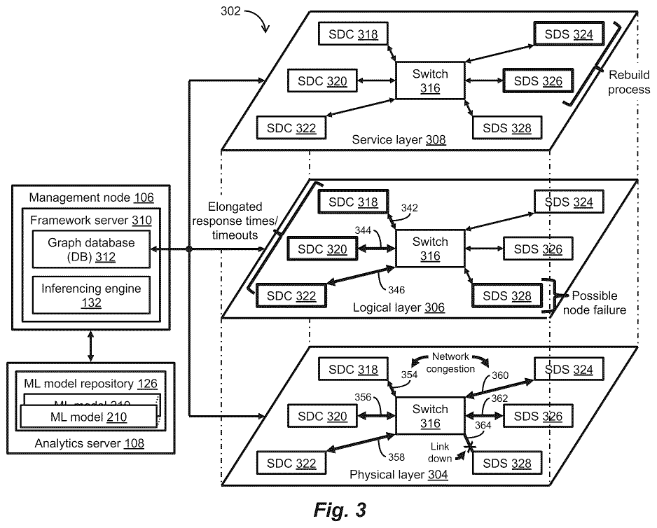

The disclosed techniques for providing an ML-based framework for detecting and troubleshooting network-related issues in large storage networks or fabrics will be further understood with reference to the following illustrative example and FIGS. 1-3. In this example, it is assumed that, with respect to the framework 200 (see FIG. 2), model inference is performed by the management node 106 (see FIGS. 1 and 3) at an edge deployment, providing real-time detection and in-context alerting capabilities without requiring continuous connectivity to the distributed storage infrastructure. It is noted, however, that such model inference can alternatively be performed within the distributed storage infrastructure by the analytics server 108 (see FIGS. 1-3).

As shown in FIG. 3, the management node 106 includes a specialized framework server component (“framework server”) 310, which implements a graph database (DB) 312 and the inferencing engine 132. In this example, the management node 106 maintains a multilayer representation 302 of the distributed storage infrastructure, and obtains and stores, in the graph DB 312 in a decoupled fashion, information pertaining to multiple topology layers, namely, a physical layer 304, a logical layer 306, and a service layer 308. In the multilayer representation 302, a plurality of storage data clients (SDCs) 318, 320, 322 are communicably coupled, via a switch 316, to a plurality of storage data servers (SDSs) 324, 326, 328. Each SDC 318, 320, 322 corresponds to a respective host computer (“host”), and each SDS 324, 326, 328 corresponds to a respective computing/storage node (“node”). It is noted that the multilayer representation 302 of FIG. 3 is described herein for purposes of illustration only, and that the multilayer representation 302 may alternatively represent an infrastructure of any suitable numbers and types of hosts, nodes, frontend/backend servers, SDCs, SDSs, NICs, routers, frontend/backend network switches, gateways, aggregators, links, cables, wireless connectivity, and so on.

In this example, representations of the SDCs 318, 320, 322 and the SDSs 324, 326, 328 are separated into the multiple topology layers, namely, the physical layer 304, the logical layer 306, and the service layer 308. The physical layer 304 provides a representation of physical hardware or resources (e.g., hosts (SDCs), nodes (SDSs), switches) on the network. The physical layer 304 can include information pertaining to different types of the physical hardware or resources, as well as telemetry counters and/or events (e.g., link events, failure events) related to the physical layer 304. The logical layer 306 provides a representation of which hosts (SDCs) are currently communicating with (or logically associated with) which nodes (SDSs) over the network. The logical layer 306 can include information pertaining to logical associations between the physical hardware or resources, as well as telemetry information (e.g., response times, IO timeouts), events, and/or configurations associated with the logical associations. The service layer 308 provides a representation of processes or services (e.g., rebuild processes) currently being performed or provided by the physical hardware or resources in the physical layer 304. Communication links or paths (e.g., LAN, WAN) between the physical hardware or resources in the logical layer 306, as well as resource allocations in the physical layer 304, can be determined and/or made in the service layer 308. The graph DB 312 can be traversed to track physical, logical, and service relationships between the physical hardware or resources (e.g., hosts (SDCs), nodes (SDSs), switches) in the physical layer 304, the logical layer 306, and the service layer 308. In this way, information can be obtained from the graph DB 312 pertaining to the physical network topology, the logical associations existing between the physical hardware or resources, and the processes or services utilizing the physical hardware or resources. For example, the physical layer 304, the logical layer 306, and the service layer 308 may be mapped in the graph DB 312 using a combination of standard protocols (e.g., Simple Network Management Protocol (SNMP), Internet Control Message Protocol (ICMP), sampled Flow (sFlow)), and/or proprietary APIs (e.g., VMware vCenter® API, Dell Powerflex® API), thereby enabling multilayer network discovery.

In this example, framework clients included in the physical hardware or resources (e.g., hosts (SDCs), nodes (SDSs), switches) collect telemetry data pertaining to the respective physical hardware or resources, and forward or stream the telemetry data to the framework server 310 included in the management node 106. Further, it is assumed that information pertaining to the physical layer 304, the logical layer 306, and/or the service layer 308, stored in the graph DB 312, indicates a failure (or suspected failure) of the SDS 328 (see FIG. 3). For example, a node failure may be indicated, in the physical layer information, by a status of a link or path 364 (see FIG. 3) transitioning from “up” to “down”. Alternatively, or in addition, the node failure may be indicated, in the logical layer information, by IO timeouts occurring between the SDCs 318, 320, 322 and the SDS 328 (e.g., acknowledgements regarding write completions may not be received within a specified timeout period).

In response to the failure of the SDS 328, a rebuild process is initiated between the SDS 324 and the SDS 326 to rebuild volumes stored on storage devices associated with the failed node. For example, the rebuild process involving the SDS 324 and the SDS 326 may be indicated in the service layer information. As the rebuild process proceeds, additional information pertaining to the physical layer 304, the logical layer 306, and the service layer 308 continues to be obtained by the management node 106 and stored in the graph DB 312. In this example, the additional physical layer information indicates increased node port utilization on the SDSs 324, 326 due to the rebuild process. Unfortunately, this increased node port utilization causes ripple effects through the distributed storage infrastructure, ultimately causing users of the SDCs 318, 320, 322 to experience unwanted service disruption and/or IO performance degradation. For example, the additional logical layer information may indicate ripple effects such as elongated response times between the SDCs 318, 320, 322 and the SDSs 324, 326, and/or IO timeouts occurring between the SDCs 318, 320, 322 and the SDS 328.

In this example, to determine or detect a network-related issue (e.g., network congestion) causing the unwanted service disruption and/or IO performance degradation, the management node 106 makes a connection to the analytics server 108 to access one or more of the ML models 210 from the ML model repository 126, as well as telemetry data, metrics, and/or statistics obtained by the analytics server 108 from throughout the distributed storage infrastructure. For example, the analytics server 108 may deploy, to the management node 106, a first ML model based on a classification algorithm trained to detect a presence of network congestion, a second ML model based on a regression algorithm trained to determine a level of network congestion, and so on. Further, the inferencing engine 132 of the management node 106 may perform inference on the telemetry data, metrics, and/or statistics, using the first ML model, to detect the presence of network congestion in the distributed storage infrastructure, as well as perform inference on the telemetry data, metrics, and/or statistics, using the second ML model, to determine the level of the network congestion. For example, the telemetry data, metrics, and/or statistics may include, but are not limited to, the following:
the number of discarded packets (DiscardedPkts);
the number of FCOE/IP login failures (FCOElinkFailures);
the number of good (FCS valid) packets received (FCOEPktRxCount);
the number of good (FCS valid) packets transmitted (FCOEPktTxCount);
the total number of RDMA packets received (RDMARxTotalPackets);
the total number of RDMA bytes transmitted (RDMATxTotalBytes);
the total number of RDMA packets transmitted (RDMATxTotalPackets);
the number of bytes received (RxBytes);
the number of packets received with FCS errors (RxErrorPktFCSErrors);
the number of frames that are too long (RxJabberPkt); and
the number of bytes transmitted (TxBytes).

Further, in this example, to identify an overall context of the network-related issue (e.g., network congestion), the management node 106, using the inferencing engine 132, performs inference to correlate the detected network congestion with an activity, service, and/or status of the SDCs 318, 320, 322, the SDSs 324, 326, 328, the switch 316, and/or their associated links or paths with respect to the physical layer 304, the logical layer 306, and/or the service layer 308. For example, based on results of the correlation, conditions relating to the overall context of the network congestion may be determined to include, (i) with respect to the physical layer 304, possible network congestion on paths 360, 362 and paths 354, 356, 358 due to the rebuild process in the service layer 308, as well as a status of the path 364 transitioning from “up” to “down”, and, (ii) with respect to the logical layer 306, elongated response times from the SDSs 324, 326 to the SDCs 318, 320, 322 over their associated paths 342, 344, 346, as well as IO timeouts occurring between the SDS 328 and the SDCs 318, 320, 322 over their associated paths 342, 344, 346.

Having identified the overall context of the network-related issue (e.g., network congestion), the management node 106 uses the inferencing engine 208 to generate in-context alerts, as well as create log events based on the in-context alerts. For example, such in-context alerts relating to network congestion may be formatted, as follows:

$$Congestion detected between SDC < \text{} Hostname > < IP > and SDS < Hostname > < IP \text{>,} \qquad ( 1 )$$

in which “<Hostname> <IP>” corresponds to the host name (e.g., human-readable label) and Internet Protocol (IP) address (e.g., numerical identifier) of an SDC or SDS experiencing the network congestion. Log events based on the in-context alerts can include multiple fields corresponding to a date/time, cluster/node number, component, logging level, text, and so on. For example, the date/time field may contain a creation date and time for a log entry, the cluster/node number field may contain an identifier of a cluster/node that initiated logging, and the component field may contain an identifier of a component that initiated the logging (e.g., the management node 106). Further, the level field may contain a value or string defining a type of the log event (e.g., status, warning, error, debug), and the text field may contain human-readable text (e.g., elongated response times due to failure of SDS 328, increased network congestion due to rebuild process involving SDS 324 and SDS 326), which host, network, and/or storage administrators can read and evaluate. The management node 106 can send the in-context alerts and log events to the SDCs 318, 320, 322 for display on their associated user interfaces (UIs) to provide the host, network, and/or storage administrators with relevant, informative, useful, and/or actionable notifications based on the network-related issue (e.g., network congestion).

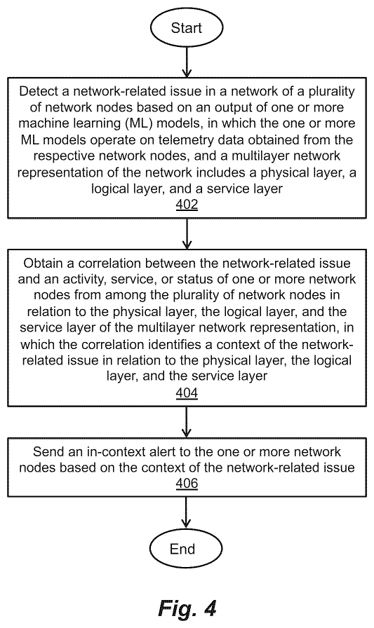

A method of providing a machine learning (ML) based framework for detecting and troubleshooting network related issues in large storage fabrics is described herein with reference to FIG. 4. As depicted in block 402, a network-related issue is detected in a network of a plurality of network nodes based on an output of one or more machine learning (ML) models, in which the one or more ML models operate on telemetry data obtained from the respective network nodes, and a multilayer network representation of the network includes a physical layer, a logical layer, and a service layer. As depicted in block 404, a correlation is obtained between the network-related issue and an activity, service, or status of one or more network nodes from among the plurality of network nodes in relation to the physical layer, the logical layer, and the service layer of the multilayer network representation, in which the correlation identifies a context of the network-related issue in relation to the physical layer, the logical layer, and the service layer. As depicted in block 406, an in-context alert is sent, to the one or more network nodes, based on the context of the network-related issue.

Having described the above illustrative embodiments, various alternative embodiments and/or variations may be made and/or practiced. For example, regarding the framework 200 (see FIG. 2), it was described herein that the framework clients 224, 230, 238 can create log events (e.g., date/time, cluster/node number, component, logging level, text) based on in-context alerts forwarded by the framework server 236, and display the in-context alerts and log events on the respective UIs 222, 226, 232. In one embodiment, such log events can be used to facilitate Root-Cause Analysis (RCA) of unwanted service disruptions and/or IO performance degradations. For example, with reference to an illustrative example, it was described herein that, in response to a network-related issue (e.g., network congestion), a log event may be created with a text field containing human-readable text, e.g., “elongated response times due to failure of SDS 328” (see FIG. 3), and/or “increased network congestion due to rebuild process involving SDS 324 and SDS 326” (see FIG. 3). Having read and evaluated the log event, a host, network, or storage administrator may determine that (i) elongated response times were caused by increased network congestion, (ii) the increased network congestion was caused by a rebuild process, and (iii) the rebuild process was initiated by a failure of a node. In this way, the host, network, or storage administrator may pinpoint the source of an unwanted service disruption or IO performance degradation, determining that the root cause of the service disruption or IO performance degradation, namely, elongated response times in the logical layer 306, is the failure of a node (e.g., SDS 328) in the physical layer 304.

It was further described herein that the inferencing engine 208 of the framework 200 (see FIG. 2) can access datasets of recently obtained features from the feature DB 206, as well as access one or more of the ML models 210 from the ML model repository 126, to detect and troubleshoot issues related to a network. In one embodiment, based on the specific network-related issues, in-context alerts can be generated to include troubleshooting and/or remediation suggestions in multiple levels of sophistication. For example, in a first level, users may be alerted of a general context of a service disruption or IO performance degradation. For example, a user may be notified about a suspicious behavior where an ML model score (e.g., for classification or regression) exceeds a specific threshold set by the user, as well as be provided with any relevant information to help the user investigate the service disruption or IO performance degradation. In a second level, users may be provided with one or more troubleshooting or remediation options, along with information to help them choose the option that best suits their needs and/or preferences. For example, the troubleshooting or remediation options may be based on a rule base, or extracted from a knowledge base (e.g., a list of known issues) using a Large Language Model (LLM) and a Retrieval Augmented Generation (RAG) system. In a third level, the framework 200 may be configured to perform, per user approval, automatic fixes (“auto-fixes”) of network-related issues. For example, such auto-fixes may be performed by executing one or more custom scripts from relevant knowledge base articles or a rule base. It is noted that, in a rule-based system, a collection of predefined rules can be applied by an inference engine to reach conclusions based on given conditions.

It was further described herein that, in response to processing datasets using the ML models 210, the inferencing engine 208 can detect, by model inference, one or more network-related issues, such as network or node misconfiguration, node failure, network congestion, suboptimal network performance, and so on. In one embodiment, a multi-faceted ML approach can be used to effectively detect and manage network congestion and/or other network-related issues. For example, time-series analysis, supervised learning, and feature engineering may be used to model temporal dynamics and dependencies inherent in telemetry data from various network components. Moreover, in addition to the telemetry data, metrics, and/or statistics described herein, the following telemetry data, metrics, and/or statistics may be collected to infer such network-related issues:
the total number of FC CRC errors (FCCRCErrorCount);
the number of bad (FCS invalid) packets dropped (FCOERxPktDroppedCount);
the number of LAN FCS errors received (LanFCSRxErrors);
the number of LAN unicast packets received (LanUnicastPktRxCount);
the number of LAN unicast packets received (LanUnicastPktTxCount);
the status of a link (LinkStatus);
the operating system driver state (OSDriverState);
the status of a partition link (PartitionLinkStatus);
the partition operating system driver state (PartitionOSDriverState);
the total number of RDMA bytes received (RDMARxTotalBytes);
the total number of RDMA protection errors (RDMATotalProtectionErrors);
the total number of RDMA protocol errors (RDMATotalProtocolErrors);
the total number of RDMA transmit packets read (RDMATxTotalReadReqPkts);
the total number of RDMA transmit packets sent (RDMATxTotalSendPkts);
the total number of RDMA transmit packets written (RDMATxTotalWritePkts);
the number of broadcast packets received (RxBroadcast);
the number of packets received with alignment errors (RxErrorPktAlignmentErrors);
the number of false carrier/receive detected (RxFalseCarrierDetection);
the number of multicast packets received (RxMutlicast);
the number of transmit OFF frames (receive pause) transmitted (RxPauseXOFFFrames);
the number of transmit ON frames (receive pause) transmitted (RxPauseXONFrames);
the number of runt packets received (RxRuntPkt);
the number of unicast packets received (RxUnicast);
the number of broadcast packets received (TxBroadcast);
the number of multicast packets transmitted (TxMutlicast);
the number of transmit OFF frames (transmit pause) received (TxPauseXOFFFrames);
the number of transmit ON frames (transmit pause) received (TxPauseXONFrames); and
the number of unicast packets transmitted (TxUnicast).

In this multi-faceted ML approach, the telemetry preprocessing component 202 of the framework 200 (see FIG. 2) can be configured to perform (i) normalization techniques (e.g., min-max scaling) on the telemetry data to ensure uniformity, (ii) missing value handling techniques (e.g., forward filling, backward filling, interpolation) to address any missing values in the telemetry data, and/or (iii) temporal alignment techniques to synchronize telemetry data streams from different sources to ensure temporal coherence. Further, to capture the temporal nature and interaction of telemetry variables over time, the feature engineering component 204 of the framework 200 (see FIG. 2) can be configured to derive features (or attributes) such as (i) time-lagged variables, which are lagged over various time steps to capture temporal dependencies, (ii) rolling statistics such as rolling means, standard deviations, and moving averages calculated over different time windows to identify trends and anomalies, and/or (iii) derived metrics such as ratios and differences between key metrics (e.g., TxBytes to RxBytes) to highlight potential congestion points.

It is noted that the architecture of the ML models 210 (see FIG. 2) can take into account ensemble techniques, as well as sequence or time-related algorithms. Regarding ensemble techniques, Random Forest algorithms can be used to provide a baseline due to their flexibility and ability to handle feature interactions and non-linearities. Regarding sequence or time-related algorithms, in view of network disturbances possibly developing over time with ripple effects through the network, algorithms such as Recurrent Neural Network (RNN) algorithms, or Generative Pre-trained Transformer (GPT)-like RNN algorithm variations such as Receptance Weighted Key Value (RWKV) or MAMBA can be employed. The ML models 210 can be trained on a labeled dataset where the target variable indicates the presence or absence of a network-related issue, such as network congestion. Further, time-series aware cross-validation techniques such as rolling or expanding window cross-validation can be used to ensure robust performance evaluation, and hyperparameter tuning techniques such as grid search or random search can be used to optimize model hyperparameters for optimal performance. The ML models 210 can be evaluated based on metrics relating to (i) accuracy, to measure the overall correctness of the ML model, (ii) precision and recall, to evaluate the ML model's performance in identifying actual network congestion and avoiding false positives, (iii) F1 score, i.e., the harmonic mean of the precision and recall, particularly regarding imbalanced datasets, and/or (iv) Receiver Operating Characteristic-Area Under the Curve (ROC-AUC), to assess the ML model's discriminative ability across various threshold settings. In addition, techniques such as SHAP (Shapley additive explanations) can be used to interpret feature contributions and ensure transparency of the ML models 210.

It is further noted that, to enhance performance of the ML models 210 and their ability to adapt to evolving network conditions, a continuous feedback loop can be established that includes (i) periodic ML model retraining with new telemetry data to capture emerging patterns, (ii) tracking overall ML model performance and statistical distribution of relevant features to detect ML model or concept drift, and to trigger training and deployment of new ML models, as desired and/or required, and/or (iii) integrating feedback from host, network, and/or storage administrators to refine ML model forecasts and reduce false positives/negatives. By leveraging a comprehensive ML methodology to detect network-related issues in distributed storage systems, as described herein, enhanced fault resilience, optimized troubleshooting and remediation, and reduced downtime and IO performance degradation can be achieved.

Several definitions of terms are provided below for the purpose of aiding the understanding of the foregoing description, as well as the claims set forth herein.

As employed herein, the term “storage system” is intended to be broadly construed to encompass, for example, private or public cloud computing systems for storing data, as well as systems for storing data comprising virtual infrastructure and those not comprising virtual infrastructure.

As employed herein, the terms “client,” “host,” and “user” refer, interchangeably, to any person, system, or other entity that uses a storage system to read/write data.

As employed herein, the term “storage device” may refer to a storage array including multiple storage devices. Such a storage device may refer to any non-volatile memory (NVM) device, including hard disk drives (HDDs), solid state drives (SSDs), flash devices (e.g., NAND flash devices, NOR flash devices), and/or similar devices that may be accessed locally and/or remotely, such as via a storage area network (SAN).

As employed herein, the term “storage array” may refer to a storage system used for block-based, file-based, or other object-based storage. Such a storage array may include, for example, dedicated storage hardware containing HDDs, SSDs, and/or all-flash drives.

As employed herein, the term “storage entity” may refer to a filesystem, an object storage, a virtualized device, a logical unit (LUN), a logical volume (LV), a logical device, a physical device, and/or a storage medium.

As employed herein, the term “LUN” may refer to a logical entity provided by a storage system for accessing data from the storage system and may be used interchangeably with a logical volume (LV). The term “LUN” may also refer to a logical unit number for identifying a logical unit, a virtual disk, or a virtual LUN.

As employed herein, the term “physical storage unit” may refer to a physical entity such as a storage drive or disk or an array of storage drives or disks for storing data in storage locations accessible at addresses. The term “physical storage unit” may be used interchangeably with the term “physical volume.”

As employed herein, the term “storage medium” may refer to a hard drive or flash storage, a combination of hard drives and flash storage, a combination of hard drives, flash storage, and other storage drives or devices, or any other suitable types and/or combinations of computer readable storage media. Such a storage medium may include physical and logical storage media, multiple levels of virtual-to-physical mappings, and/or disk images. The term “storage medium” may also refer to a computer-readable program medium.

As employed herein, the term “IO request” or “IO” may refer to a data input or output request such as a read request or a write request.

As employed herein, the term “FC” refers to Fibre Channel, the term “FCOE” refers to Fibre Channel over Ethernet, the term “CRC” refers to Cyclic Redundancy Check, the term “FCS” refers to Frame Check Sequence, the term “RDMA” refers to Remote Direct Memory Access, the term “LAN” refers to Local Area Network, and the term “WAN” refers to Wide Area Network.

As employed herein, the terms, “such as,” “for example,” “e.g.,” “exemplary,” and variants thereof refer to non-limiting embodiments and have meanings of serving as examples, instances, or illustrations. Any embodiments described herein using such phrases and/or variants are not necessarily to be construed as preferred or more advantageous over other embodiments, and/or to exclude incorporation of features from other embodiments.

As employed herein, the term “optionally” has a meaning that a feature, element, process, etc., may be provided in certain embodiments and may not be provided in certain other embodiments. Any particular embodiment of the present disclosure may include a plurality of optional features unless such features conflict with one another.

While various embodiments of the present disclosure have been particularly shown and described, it will be understood by those skilled in the art that various changes in form and details may be made therein without departing from the scope of the present disclosure, as defined by the appended claims.

What is claimed is:

1. A method comprising:
detecting a network-related issue in a network of a plurality of network nodes based on an output of one or more machine learning (ML) models, the one or more ML models operating on telemetry data obtained from the respective network nodes, a multilayer network representation of the network including a service layer, a logical layer, and a physical layer;
obtaining a correlation between the network-related issue and a service, an activity, or a status of one or more network nodes from among the plurality of network nodes in relation to the service layer, the logical layer, and the physical layer of the multilayer network representation, the correlation identifying a context of the network-related issue in relation to the service layer, the logical layer, and the physical layer; and
sending, to the one or more network nodes, an in-context alert based on the context of the network-related issue.

2. The method of claim 1 comprising:
providing a computer-executable framework for detecting the network-related issue and obtaining the correlation between the network-related issue and the service, the activity, or the status of the one or more network nodes, the computer-executable framework including at least an ML model repository, an inferencing engine, and a specialized server component.

3. The method of claim 2 wherein the plurality of network nodes includes a plurality of computing nodes, and wherein the providing of the computer-executable framework includes providing a specialized client component associated with each respective computing node.

4. The method of claim 3 comprising:
collecting, by the specialized client component, telemetry data pertaining to each respective computing node; and
forwarding the telemetry data to the specialized server component.

5. The method of claim 4 comprising:
obtaining information pertaining to the service layer, the logical layer, and the physical layer of the multilayer network representation, the obtained information indicating the network-related issue associated with a network node from among the plurality of network nodes, the network-related issue causing performance degradation on the network.

6. The method of claim 5 comprising:
accessing at least one ML model from the ML model repository; and
accessing the telemetry data from the specialized server component,
wherein the detecting of the network-related issue includes performing inference, by the inferencing engine, on the telemetry data using the at least one ML model.

7. The method of claim 6 wherein the obtaining of the correlation between the network-related issue and the service, the activity, or the status of the one or more network nodes in relation to the service layer, the logical layer, and the physical layer includes correlating the network-related issue with the service performed by the one or more network nodes in the service layer, the activity performed by the one or more network nodes in the logical layer, and the status of the one or more network nodes in the physical layer.

8. The method of claim 1 wherein the sending of the in-context alert based on the context of the network-related issue includes suggesting a troubleshooting action to be performed regarding the network-related issue.

9. A system comprising:
a memory; and
processing circuitry configured to execute program instructions out of the memory to:
detect a network-related issue in a network of a plurality of network nodes based on an output of one or more machine learning (ML) models,
wherein the one or more ML models operate on telemetry data obtained from the respective network nodes, and
wherein a multilayer network representation of the network includes a service layer, a logical layer, and a physical layer;
obtain a correlation between the network-related issue and a service, an activity, or a status of one or more network nodes from among the plurality of network nodes in relation to the service layer, the logical layer, and the physical layer of the multilayer network representation,
wherein the correlation identifies a context of the network-related issue in relation to the service layer, the logical layer, and the physical layer; and
send, to the one or more network nodes, an in-context alert based on the context of the network-related issue.

10. The system of claim 9 wherein the processing circuitry is configured to execute the program instructions out of the memory to:
provide a computer-executable framework for detecting the network-related issue and obtaining the correlation between the network-related issue and the service, the activity, or the status of the one or more network nodes,
wherein the computer-executable framework includes at least an ML model repository, an inferencing engine, and a specialized server component.

11. The system of claim 10 wherein the plurality of network nodes includes a plurality of computing nodes, and wherein the processing circuitry is configured to execute the program instructions out of the memory to:
provide a specialized client component associated with each respective computing node.

12. The system of claim 11 wherein the processing circuitry is configured to execute the program instructions out of the memory to:
collect, by the specialized client component, telemetry data pertaining to each respective computing node; and
forward the telemetry data to the specialized server component.

13. The system of claim 12 wherein the telemetry data includes at least some of:
a number of discarded packets (DiscardedPkts);
a number of FCOE/IP login failures (FCOElinkFailures);
a number of good (FCS valid) packets received (FCOEPktRxCount);
a number of good (FCS valid) packets transmitted (FCOEPktTxCount);
a total number of RDMA packets received (RDMARxTotalPackets);
a total number of RDMA bytes transmitted (RDMATxTotalBytes);
a total number of RDMA packets transmitted (RDMATxTotalPackets);
a number of bytes received (RxBytes);
a number of packets received with FCS errors (RxErrorPktFCSErrors);
a number of frames that are too long (RxJabberPkt); and
a number of bytes transmitted (TxBytes).

14. The system of claim 13 wherein the telemetry data includes at least some of:
a total number of FC CRC errors (FCCRCErrorCount);
a number of bad (FCS invalid) packets dropped (FCOERxPktDroppedCount);
a number of LAN FCS errors received (LanFCSRxErrors);
a number of LAN unicast packets received (LanUnicastPktRxCount);
a number of LAN unicast packets received (LanUnicastPktTxCount);
a status of a link (LinkStatus);
an operating system driver state (OSDriverState);
a status of a partition link (PartitionLinkStatus);
a partition operating system driver state (PartitionOSDriverState);
a total number of RDMA bytes received (RDMARxTotalBytes);
a total number of RDMA protection errors (RDMATotalProtectionErrors);
a total number of RDMA protocol errors (RDMATotalProtocolErrors);
a total number of RDMA transmit packets read (RDMATxTotalReadReqPkts); and
a total number of RDMA transmit packets sent (RDMATxTotalSendPkts).

15. The system of claim 14 wherein the telemetry data includes at least some of:
a total number of RDMA transmit packets written (RDMATxTotalWritePkts);
a number of broadcast packets received (RxBroadcast);
a number of packets received with alignment errors (RxErrorPktAlignmentErrors);
a number of false carrier/receive detected (RxFalseCarrierDetection);
a number of multicast packets received (RxMutlicast);
a number of transmit OFF frames (receive pause) transmitted (RxPauseXOFFFrames);
a number of transmit ON frames (receive pause) transmitted (RxPauseXONFrames);
a number of runt packets received (RxRuntPkt);
a number of unicast packets received (RxUnicast);
a number of broadcast packets received (TxBroadcast);
a number of multicast packets transmitted (TxMutlicast);
a number of transmit OFF frames (transmit pause) received (TxPauseXOFFFrames);
a number of transmit ON frames (transmit pause) received (TxPauseXONFrames); and
a number of unicast packets transmitted (TxUnicast).

16. The system of claim 12 wherein the processing circuitry is configured to execute the program instructions out of the memory to:
obtain information pertaining to the service layer, the logical layer, and the physical layer of the multilayer network representation,
wherein the obtained information indicates the network-related issue associated with a network node from among the plurality of network nodes, and
wherein the network-related issue causes performance degradation on the network.

17. The system of claim 16 wherein the processing circuitry is configured to execute the program instructions out of the memory to:
access at least one ML model from the ML model repository;
access the telemetry data from the specialized server component; and
perform inference, by the inferencing engine, on the telemetry data using the at least one ML model.

18. The system of claim 17 wherein the processing circuitry is configured to execute the program instructions out of the memory to:
correlate the network-related issue with the service performed by the one or more network nodes in the service layer, the activity performed by the one or more network nodes in the logical layer, and the status of the one or more network nodes in the physical layer.

19. The system of claim 9 wherein the processing circuitry is configured to execute the program instructions out of the memory to:
suggest a troubleshooting action to be performed regarding the network-related issue.

20. A computer program product including a set of non-transitory, computer-readable media having program instructions that, when executed by processing circuitry, cause the processing circuitry to perform a method comprising:
detecting a network-related issue in a network of a plurality of network nodes based on an output of one or more machine learning (ML) models, the one or more ML models operating on telemetry data obtained from the respective network nodes, a multilayer network representation of the network including a service layer, a logical layer, and a physical layer;
obtaining a correlation between the network-related issue and a service, an activity, or a status of one or more network nodes from among the plurality of network nodes in relation to the service layer, the logical layer, and the physical layer of the multilayer network representation, the correlation identifying a context of the network-related issue in relation to the service layer, the logical layer, and the physical layer; and
sending, to the one or more network nodes, an in-context alert based on the context of the network-related issue.
